(19) United States
(12) Patent Application Publication
(10) Pub. No.: US 2017/0126844 A1
(43) Pub. Date: May 4, 2017

(54) SERVER ARCHITECTURE AND PROTOCOL DEVELOPMENT

(71) Applicant: Microsoft Technology Licensing, LLC, Redmond, WA (US)

(72) Inventors: Baskaran Dharmarajan, Palo Alto, CA (US); Shwetha Nagaraj, San Jose, CA (US); Jose Armando Leal Alonso, San Francisco, CA (US); Krishna Sunil Yekasi, San Jose, CA (US)

(21) Appl. No.: 15/055,979

(22) Filed: Feb. 29, 2016

Related U.S. Application Data
(60) Provisional application No. 62/248,457, filed on Oct. 30, 2015.

(51) Int. Cl. H04L 29/06; H04L 12/58; H04L 29/08

(52) U.S. Cl. CPC H04L 67/42; H04L 67/10; H04L 51/046; H04L 63/08

(57) ABSTRACT

A client computing system comprises, in one example, a communication interface configured to communicate with a server environment that hosts a set of application services that interact in accordance with a communication protocol to provide service functionality to the client computing system, a development component configured to develop the service functionality by generating a protocol logic component that controls messaging between the set of application services using the communication protocol, and a runtime component configured to generate a message on the client computing system using the protocol logic component and send the message to the server environment.

### CROSS-REFERENCE TO RELATED APPLICATION

The present application is based on and claims the benefit of U.S. provisional patent application Ser. No. 62/248,457, filed Oct. 30, 2015, the content of which is hereby incorporated by reference in its entirety.

### BACKGROUND

Computing systems are currently in wide use. In one example computing architecture, one or more servers (or other computing system) provide users with access to services that are run or otherwise controlled by the servers. For instance, in one particular example multiple service-level systems provider user access to independent services in a manner that requires frequent communication between the services to implement and surface the functionality to the users.

The discussion above is merely provided for general background information and is not intended to be used as an aid in determining the scope of the claimed subject matter.

### SUMMARY

A client computing system comprises, in one example, a communication interface configured to communicate with a server environment that hosts a set of application services that interact in accordance with a communication protocol to provide service functionality to the client computing system, a development component configured to develop the service functionality by generating a protocol logic component that controls messaging between the set of application services using the communication protocol, and a runtime component configured to generate a message on the client computing system using the protocol logic component and send the message to the server environment.

A computer system comprises, in one example, a service component configured to provide a first application service to a client device, a communication interface configured to communicate with the client device and a second application service, an authentication component configured to authenticate the client device using a first authentication scheme and authenticate the second application service using a second authentication scheme, and a proxy component. The proxy component is configured to receive an event message from the second application service, send the event message to the client device, receive a response to the event message from the client device, and send the response to the second application service.

A computer-implemented method comprises, in one example, generating a client interface at a client device, receiving a development input through the client interface indicative of a development of service functionality in a server environment, wherein the server environment hosts a set of application services that interact in accordance with a communication protocol, generating a protocol logic component based on the development input using a computer processor, receiving an event message from the server environment indicative of a service event in the server environment, generating a response to the event message using the protocol logic component on the client device, and sending the response to the server environment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram illustrating one example of a computing system architecture that utilizes a client driven approach for developing and running protocol logic.

FIG. 2 is a block diagram of an example process for providing services to a client device.

FIG. 3 is a flow diagram of an example method for providing services to a client device.

FIG. 4 illustrates one example of an email user interface that includes a meeting user input mechanism that is actuatable to initiate a meeting session.

FIG. 5 illustrates one example of an email user interface that includes a user actuatable element for activating a session link to launch a meeting session.

FIG. 6 illustrates one example of a meeting session user interface.

FIG. 7 is a flow diagram of one example of a method in which a developer utilizes a client-side development component to develop protocol logic.

FIG. 8 is a flow diagram of one example of a method in which a protocol between servers is driven from a client-side.

FIG. 9 is a flow diagram of one example of a method that utilizes a mode switching component.

FIG. 10 is a block diagram showing one example of the architecture illustrated in FIG. 1, deployed in a cloud computing architecture.

FIGS. 11-13 show various examples of mobile devices that can be used with the architecture shown in FIG. 1.

FIG. 14 is a block diagram of one example computing environment.

### DETAILED DESCRIPTION

The present disclosure pertains to a computing system architecture that provides services to users. The services can be of any of a variety of types including, but not limited to, messaging services (e.g., instant messaging, email, etc.), real-time audio/video communication services, media services, web services, gaming services, productivity services, data storage services, to name a few.

In one example, the services are provided by service-level entities, such as one or more servers operating in a server/client environment, that provide substantially independent services to user(s) on client devices. In providing the services, the server(s), or other service-level entit(ies), interact with one another in accordance with a communication protocol, to send and receive various calls, callbacks, requests, commands, or other data. In some scenarios, client-side users lack adequate, if any, visibility into the server-side communication protocol making it difficult to access, analyze, and/or develop service functionality. This can be especially true in the case of chatty protocols between the service-level entities. To illustrate, as understood by one skilled in the art, one type of chatty protocol comprises a network or other communication protocol in which servers or other systems/devices announce their availability over the network in a constant or substantially constant manner A Chatty protocol can also include a protocol that waits for an acknowledgement before sending a next data packet. In this case, the back and forth communication and transmission of packets adds to network overhead.

In an example server environment, an email server mediates communication sessions for a real-time audio/video communication server. The real-time communication server may send any and all changes and status updates that are, in many instances, of minimal and peripheral interest to the email server. In this way, the email server may be thought of as simulating a communication client for the real-time communication server to perform the rich, chatty protocol. This can cause the development process to be very difficult. That is, in scenarios in which the services are independent (i.e., not necessarily linked) and require server authentication (e.g., protected server certificates to sign requests), the deployment to the production servers is often needed in order to realistically test the protocol development. Therefore, to develop the server-side protocol logic for carrying out the server functionality and interactions, the developer is required to use trace statements and carefully craft the code changes, which are then submitted for deployment on the actual production servers before the code changes can be run and tested. In some scenarios, it can take a significant amount of time (e.g., a week or more) to propagate the code changes to the production service, if at all possible, to run a separate test environment to test the developer code. Any errors in the development code may negatively affect the production services and can be difficult to debug.

Further yet, in order to realize the effect of the code changes, the developer needs access to the server-side activities and events. However, logging all activity on the production server is generally not scalable and can result in performance issues. Even then, the developer must manually analyze the entire log in an attempt to identify relevant events to debug the system. The logs are not specific to individual users or client devices which causes the log to be of considerable size.

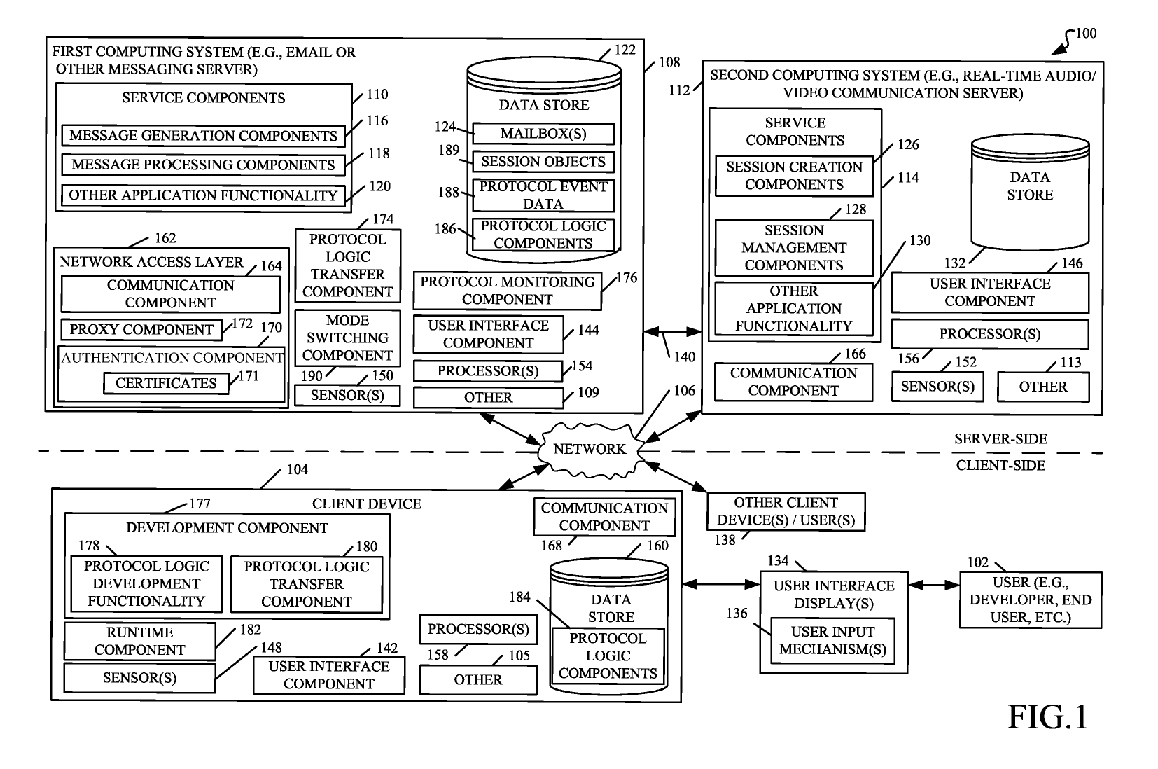

FIG. 1 is a block diagram illustrating one example of a computing system architecture 100 that utilizes a client driven approach for developing and running protocol logic for server-side communications and service functionality deployment. By developing and running the protocol logic on a client, a developer or other user can obtain visibility into the service-level communications. This can have many advantages, at least some of which are discussed below. Briefly, however, a client driven development approach can improve the developer experience by speeding up the code development, thereby allowing the developments to enter production more quickly. Further, the developer coding may be reusable across many client devices, and can target a particular client implementation. Further yet, the client drive approach enables diagnosis of problems and code debugging in a way that is highly scalable. Before discussing this client driven approach in further detail, a discussion of components in architecture 100 will be provided.

In the example of FIG. 1, computing system architecture 100 is configured to provide services to one or more users (e.g., user 102 and/or other users). The services are provided by one or more computing systems in a server/client environment. The services are generally independent, in that the respective components provide the services to a client device 104 through a network 106 in a substantially independent manner That is not to say the services are provided by components that do not interact with one another.

In the present example, a first computing system 108 includes service components 110 that host a first set of services for client device 104 and a second computing system 112 includes service components 114 that host a second set of services for client device 104. In the illustrated example, but not by limitation, computing systems 108 and 112 comprise servers in a multi-server environment, where the servers interact with client devices 104 and 138 in a client-server model. For sake of illustration but not by limitation, computing systems 108 and 112 will be described in the context of servers (referred to as servers 108 and 112. Of course, other types of computing systems can be utilized to provide service functionality to client-side end points.

In the illustrated example, server 108 is configured to interact with and mediate functions performed by server 112. For sake of illustration, but not by limitation, servers 108 and 112 will be described in the context of an email (or other messaging) server (referred to as email server 108) and a real-time audio and/or video communication server (referred to as a real-time communication server 112. Of course, other types of servers and services can be provided by architecture 100.

Service components 110 of email server 108 include message generation components 116, message processing components 118, and can include other application functionality 120 as well. Message generation components 116 provide functionality for generating and sending emails, or other types of messages, and message processing components 118 facilitate processing of received messages, which can be stored in a data store 122 (e.g., in mailboxes 124). Server 108 can include other items 109 as well.

Service components 114 of real-time communication server 112 include session creation components 126, session management components 128, and can include other application functionality 130 as well. Session creation components 126 are configured to create real-time audio and/or video communication sessions between a group (two or more) users that allow the users to exchange text and video messages, as well as to provide video chat and voice calls. A session comprises, for example, a meeting or conference call (or other event) between the group of users. Session management components 128 are configured to manage the communication sessions, such as to control various functions performed by users within the session. Server 112 can also include a data store 132 for storing various data used by service components 114, or other components, of server 112. Server 112 can include other items 113 as well.

Architecture 100 is accessible by users through user interface displays. In the illustrated example, user 102 accesses architecture 100 using user interface display(s) 134 rendered on client device 104. User interface display(s) 134 include user input mechanism(s) 136 for interaction by user 102. It is noted that while one user (i.e., user 102) is illustrated in FIG. 1 as accessing architecture 100, any number of users can access computing systems 108 and 112. This is represented by block 138.

Client device 104 can be any of a wide variety of computing devices including, but not limited to, desktop computers, laptop computers, personal digital assistants, mobile phones, tablet computers, e-reader devices, etc. Further, a given user may access architecture using a plurality of different client devices.

As illustrated, user 102 interacts with user interface display(s) 134 with user input mechanism(s) 136 to control and manipulate architecture 100. For instance, user 102 can access functionality provided by service components 110 and/or 114. While user 102 is illustrated as accessing servers 108 and/or 112 remotely through network 106 (such as the Internet or other wide area network), in another example client device 104 can be configured to communicate with servers 108 and/or 112 directly (e.g., locally). Further, it is noted that while servers 108 and 112 are illustrated as separate components, servers 108 and 112 can be the same server or set of servers and can be located remotely or locally to one another. For instance, servers 108 and 112 can communicate through network 106, or can be configured to communicate directly, as represented at reference numeral 140.

User interface display(s) 134 can be generated in any of a variety of different ways. In one example, client device 104 includes a user interface component 142 configured to generate user interface display(s) 134. In another example, user interface display(s) 134 can be generated by a user interface component 144 of server 108 and/or a user interface component 146 of server 112. For instance, user interface components 144 and 146 can be configured to generate user interface displays that are rendered on client device 104, for a web browser or other interface. That is, web pages can be requested, dynamically generated, and transmitted for rendering on client device 104. Alternatively, or in addition, client device 104 can include client applications and other components installed thereon that generate user interface display(s) 134.

User input mechanism(s) 136 sense physical activities, for example by generating the user interface displays that are used to sense user interaction with client device 104. The user interface displays can include user input mechanisms that sense user input in a wide variety of different ways, some of which are discussed below. Briefly, they can include point and click devices (e.g., a computer mouse or track ball), a keyboard (either virtual or hardware), and/or a keypad. Where the client device used to display user interface display(s) 134 is a touch-sensitive display, the inputs can be provided as touch gestures. Similarly, the user inputs can be provided by voice inputs or other natural user interface input mechanisms as well. As such, client device 104 can include one or more sensors 148 configured to detect inputs to client device 104. Servers 108 and 112 can also include sensor(s) 150 and 152, respectively.

As shown in FIG. 1, server 108 includes one or more processors 154. Likewise, computing system 112 and client device 104 can include processor(s) 156 and 158, respectively

Email server 108 is generally in a secure or protected location. As shown in FIG. 1, server 108 includes a network access layer 162 that is configured to address server 112, and to maintain a trusted relationship with server 112 and/or client device 104. Layer 162 includes a communication component 164 configured to establish and facilitate communication with server 112 (using communication component 166) and client device 104 (using communication component 168). These communication components can communicate using any suitable communication channel and protocol.

An authentication component 170 is configured to authenticate client device 104 with email server 108 using, for example, authentication cookies or other credentials. Email server 108 is also secured relative to communication server 112 by component 170, for example by component 170 signing calls, requests, messages, or other data sent to server 112 using a certificate securely stored and maintained within server 108 (e.g., in data store 122). Use of the certificate prevents, or otherwise discourages, spoofing of email server 108. As similarly mentioned above, email server 108 and communication server 112 can be in a same location, or different, remotely located locations.

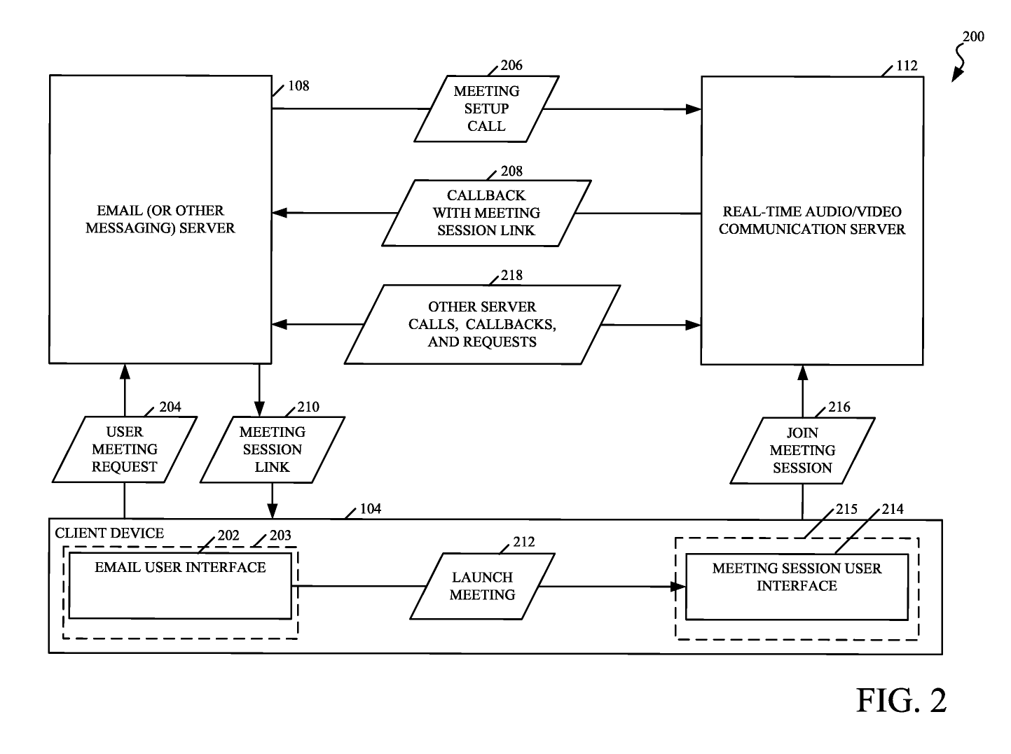

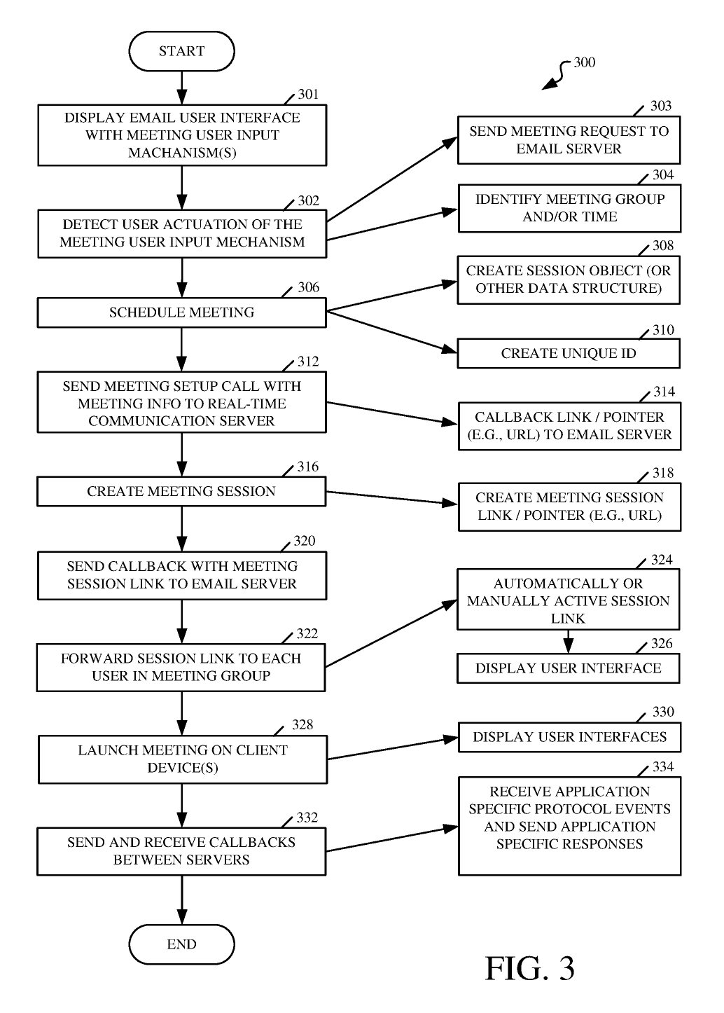

To illustrate an example operation of architecture 100, FIG. 2 is a block diagram a process 200 for providing services from servers 108 and 112 to client device 104. For sake of illustration, but not by limitation, process 200 will be described in conjunction with method 300 shown in FIG. 3, in the context of a user as a meeting organizer that initiates a group meeting event with a set of other users (i.e., one or more other users).

At block 301 of method 300, an email user interface 202 is displayed. In the illustrated example, client device 104 runs an email client 203 that presents email user interface 202, using a browser or other interface, and facilitates interaction by the user with the functionality provided by email server 108. Email user interface 202 includes meeting user input mechanisms that are actuatable by the user at block 302 to generate a meeting request 204 and to define meeting parameters and other information. For example, the user can define a meeting user group, meeting date/time, and/or other information that is provided to server 108 with meeting request 204. Sending the meeting request and identifying the meeting information is represented by blocks 303 and 304, respectively.

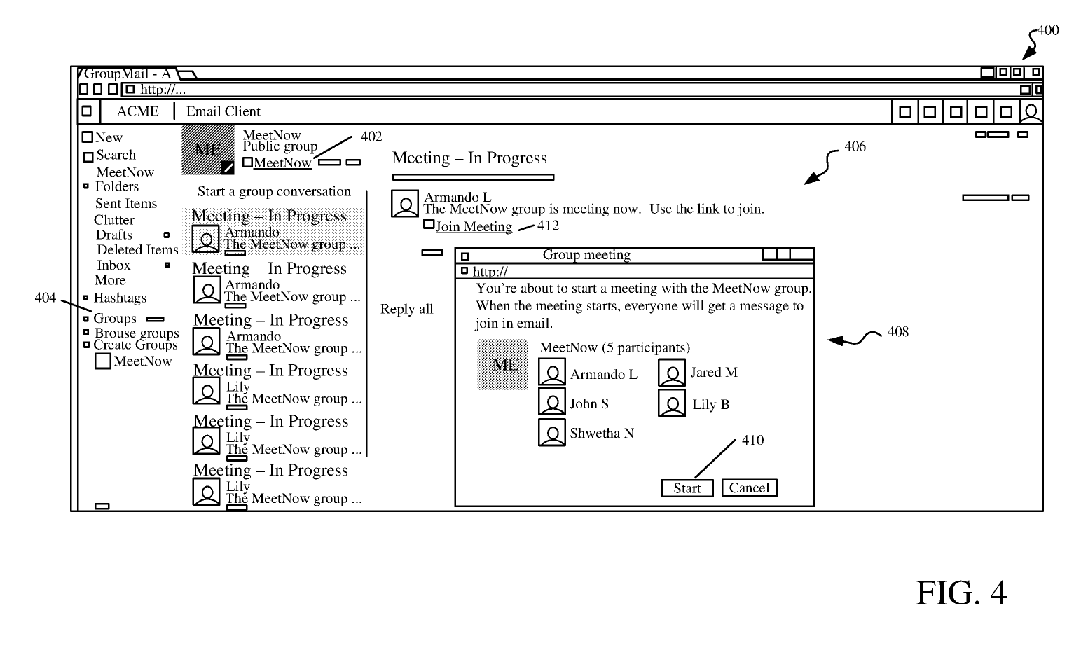

One example of an email user interface 400 is illustrated in FIG. 4. Interface 400 includes a meeting user input mechanism 402 that is actuatable by the user to initiate a meeting session with one or more other users. The other user(s) can be identified in a variety of different ways. For example, user input mechanisms within interface 400 can be utilized by the user to define a set of users, such as by selection from a group element 404. In any case, user input mechanism 402 is actuated upon which interface 400 displays a display window 406 indicating the group 408 of users who are invited to participate in the meeting session. The user can actuate a start button 410 to initiate the meeting session. Alternatively, or in addition, a join meeting user input mechanism 412 can be provided that allows the user to join the meeting session.

Referring again to FIGS. 2 and 3, at block 306 email server 108 receives meeting request 204 and schedules the meeting session based on the meeting information (e.g., meeting group and/or time). The meeting session can be immediate, or scheduled for a later time. In one example, at block 308 server 108 creates a session object (or other data structure) for the meeting session. The session object is stored in data store 122 (represented by block 189 in FIG. 1). The session object is used to store information received from client device 104 and/or server 112 for the session, as well as to monitor a state of the session. In one example, the session object can also store a unique identifier for the session that is created at block 310.

In one example, the unique identifier comprises a cryptographically safe random number that uniquely identifies the session and is virtually undiscoverable by client device 104 or other computing system(s). Server 108 appends or otherwise includes the unique identifier in all messages sent to server 112 for the meeting session, which allows server 108 to subsequently authenticate responses received from server 112.

To illustrate, at block 312 email server 108 generates and sends a meeting setup call 206 to real-time communication server 112. Meeting setup call 206 includes a callback link or pointer to email server 108 that is based on the unique identifier and enables communication server 112 to send callbacks to email server 108. For instance, the link can comprise a unified resource locator (URL) to which the unique identifier is appended. As such, server 112 is authenticated by server 108 through use of the callback URL. This is represented in FIG. 3 by block 314.

At block 316, communication server 112 creates the meeting session in response to meeting setup call 206. In the illustrated example, this includes creating a meeting session link at block 318. At block 320, communication server 112 sends a callback 208 with the meeting session link to email server 108. At block 322, email server 108 forwards the meeting session link (e.g., URL) to each user in the meeting group. This is represented in FIG. 2 at block 210 (referred to as session link 210).

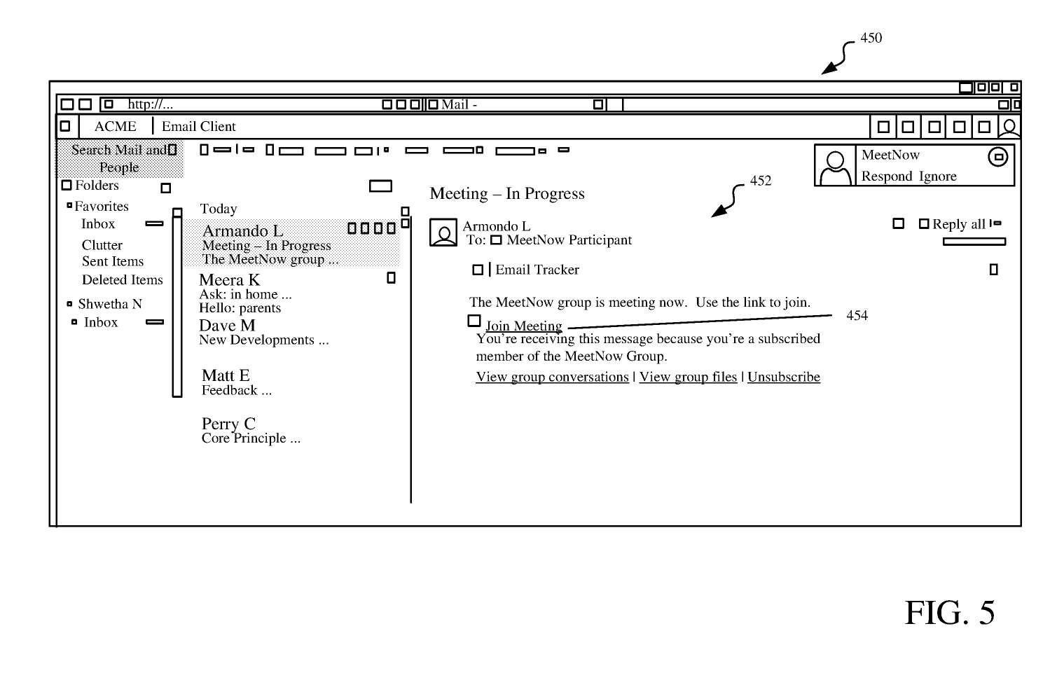

At block 324, the session link 210 is activated automatically or manually at client device 104 to launch the meeting (represented at block 212 in FIG. 2). For example, a user interface at block 326 displays the meeting information and includes a user interface element for user activation of the session link 210. One example of a user interface 450 is illustrated in FIG. 5. As shown, user interface 450 displays one or more user interface elements that identify the meeting and provide a user actuatable element 454 for activating the session link to launch the meeting on client device 104.

In response to the meeting being launched at block 328, a meeting session user interface 214 is displayed on client device 104 at block 330 and the user is joined to the meeting session (block 216).

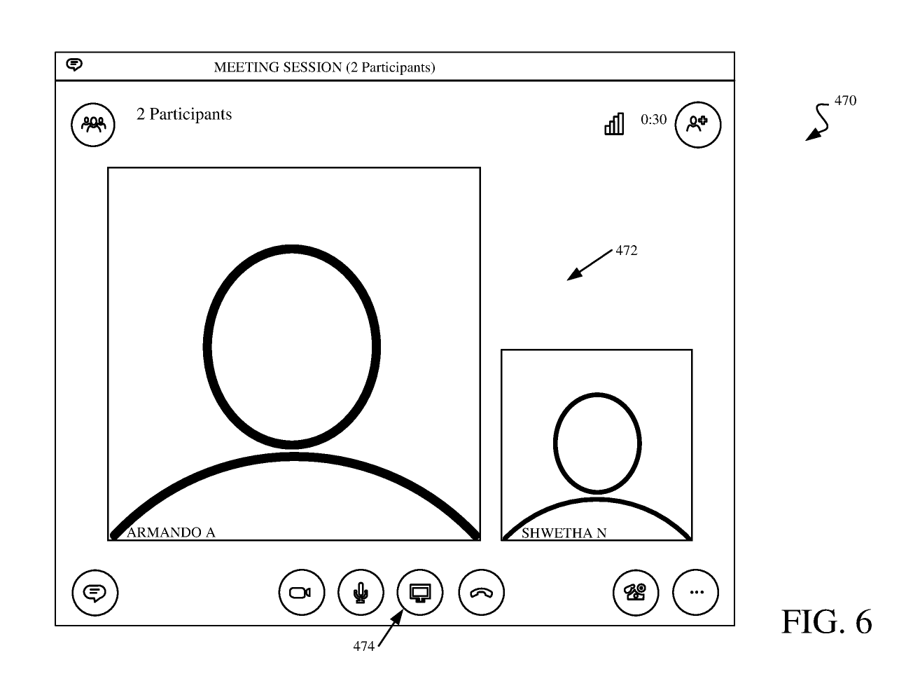

One example of a meeting session user interface 470 is illustrated in FIG. 6. As shown, a visual indication 472 is provided for participants in the meeting along with user input mechanisms 474 that allow the user to control functionality within the meeting. For example, the user can add video to the meeting, mute the audio, and exit the meeting by ending the call.

In one example, client device 104 runs a real-time audio/video communication client 215 that presents meeting session user interface 214, using a browser or other interface, and facilitates interaction by the user with the functionality provided by real-time communication server 112.

During the meeting session, email server 108 and real-time communication server 112 conduct a chatty protocol involving numerous calls, callbacks, and/or other requests sent between the servers. This is represented in FIG. 2 at block 218 and in FIG. 3 at block 332. For example, a call from server 108 can target a particular application programming interface (API), or set of APIs, on server 112. This is discussed in further detail below.

Briefly, however, through a series of calls, email server 108 operates to mediate the meeting session with communication server 112. For example, email server 108 can simulate a client of communication server 112 and provide information to communication server 112 that can be used to control the meeting session. Receiving application-specific protocol event messages and sending application-specific responses is represented in FIG. 3 at block 334. This can include a wide variety of information.

To illustrate, in the present example, communication server 112 does not have information or otherwise know the particular meeting group (i.e., users) that was established by email server 108. Email server 108 can thus provide information such as when a participant is to be added to the meeting session and when the meeting session should be terminated because all participants have ended the meeting session. Similarly, communication server 112 can provide callbacks to email server 108 to provide meeting information, indicate when a participant has joined the meeting, get participant detail, or any of a variety of other events.

As mentioned above, the protocol events and interactions between servers 108 and 112 can be virtually invisible and unknown to client device 104. As such, any protocol errors that occur on the server-side are difficult to diagnose, troubleshoot, and/or debug from the client-side. For instance, if a meeting session fails because a particular event function was unsupported or failed for some other reason, client device 104 may be unaware of the cause of the failure.

Further, a user (e.g., user 102 illustrated in FIG. 1) can be a developer who wants to develop on the services by writing code to add new functionality, remote functionality, and/or modify existing functionality in the services provided by servers 108 and 112. For example, a developer may wish to develop code to allow participants to be added with various parameters, such as allowing participants to be added when an organizer joins in a certain way. For instance, instead of joining all participants to the meeting when the organizer joins an instant messaging portion of the meeting session, the protocol logic can be developed such that participants are not joined until the organizer joins the audio portion of the meeting session. In some scenarios, participants in an audio/video communication session may disconnect from the session if the organizer has not yet joined the audio portion of the session. The developer may wish to modify the functionality to remedy this issue. In another example, the developer may wish to enable collaboration and/or document sharing functionality, and/or to provide a persistent meeting environment for documenting and storing meeting content. These, of course, are examples only.

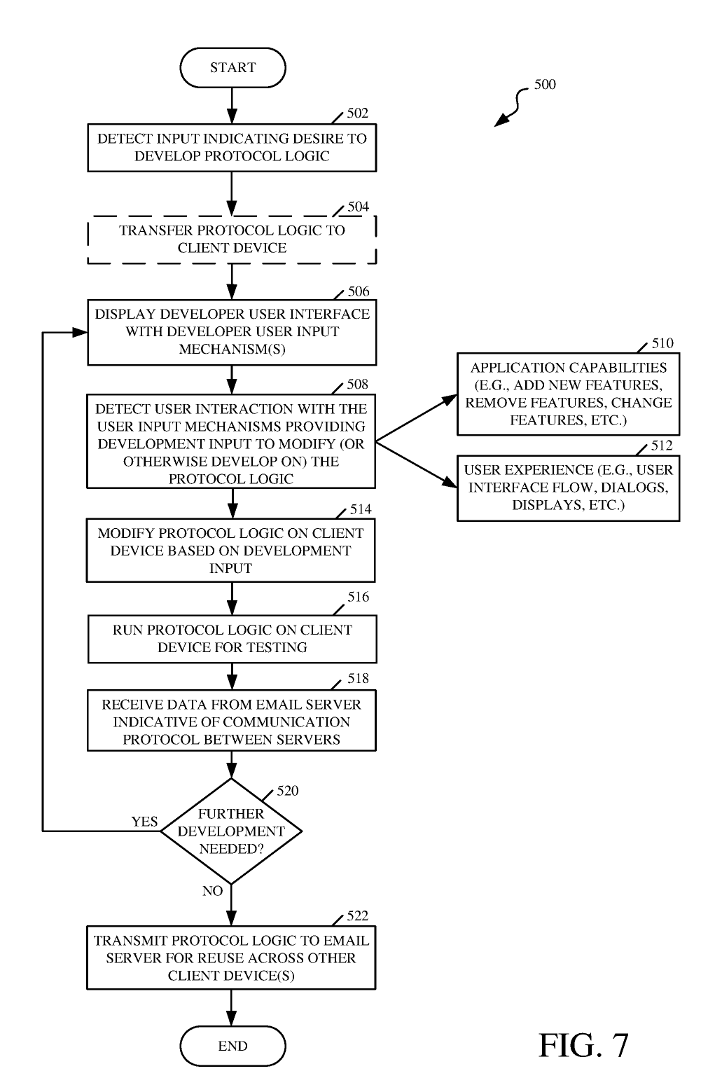

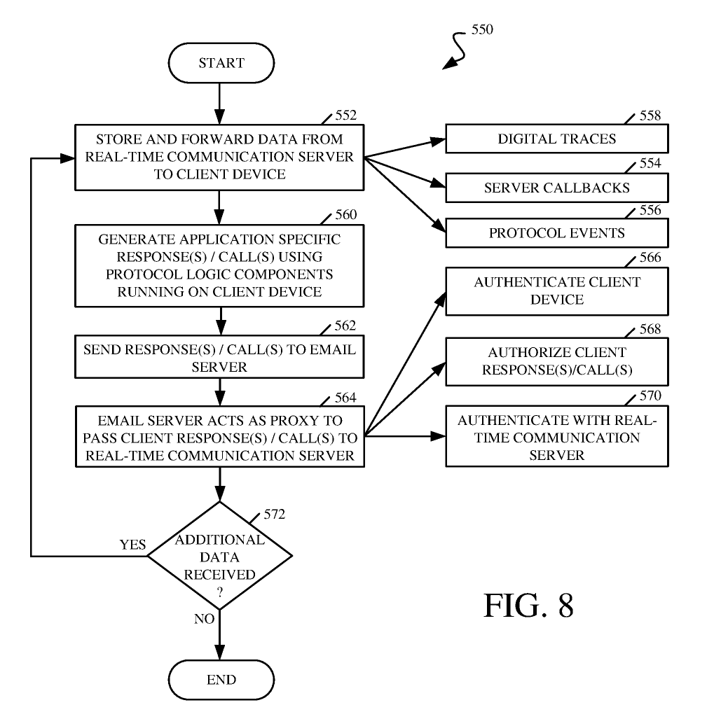

A client driven approach is facilitated in which protocol logic components (such as, but not limited to, service-level code, instructions, or other components) are developed and/or run client-side. This is discussed in further detail below with respect to FIGS. 7 and 8. Briefly, however, using the protocol logic components, client device 104 is configured to generate or otherwise control calls, callbacks, and other data between servers 108 and 112. For instance, the protocol logic components can be configured to provide application-specific event messages (e.g., event requests and/or responses to events) that are formed on client device 104, for example using scripting (e.g., JavaScript, etc.) or other coding technique. These event messages are then sent to server 108 which operates as a proxy to forward the event messages to server 112. Accordingly, the protocol logic components can be easily modified from the client-side based on desired application capabilities and user interface flows. Further, since client device 104 has visibility into the protocol event messages received from and sent to server 108, in one example user interface component is configured to generate a user interface display that displays indications of the protocol event messages to user 102. For instance, a report can be generated on client device 104 that shows the event messages received by server 108 from server 112 (and forwarded to client device 104) and the corresponding responses generated by client device 104 to those event messages. This facilitates user 102 understanding the protocol events on the server-side, identifying issues that arise in the protocol events, and debugging those issues.

As shown in FIG. 1, email server 108 includes a proxy component 172, a protocol logic transfer component 174, and a protocol monitoring component 176. Client device 104 includes a development component 177 with protocol logic development functionality 178 and a protocol logic transfer component 180. Development component 177 is configured to develop server-side functionality by generating or modifying a protocol logic component that controls messaging between servers 108 and 112.

Client device 104 also include a runtime component 182 configured to run the protocol logic components, which can be stored in data store 160 at block 184 (referred to as protocol logic components 184). Client device 104 can include other items 105 as well.

Proxy component 172 is configured to operate as a two-way proxy between client device 104 and server 112. This is discussed in further detail below. Briefly, however, proxy component 172 operates to store and forward event messages independently generated by and sent between client device 104 and server 112. In this manner, server 108 does not need to understand the underlying protocol logic, but just needs to understand the general flow of messages between client device 104 and server 112.

In operating as a proxy for client device 104, authentication component 170 enforces multiple, separate authentication schemes. A first authentication scheme is used to authenticate client device 104 with server 108. For example, a trusted relationship is formed based on a client certificate used by client device 104 to authenticate with server 108. In one example, the client certificate is based on a username and password entered by user 102 through a secured socket layer (SSL) session, or other security protocol. Similarly, client device 104 trusts server 108 through the secured session (e.g., secure hypertext transfer protocol (https), etc.).

Upon receiving messages to forward on to server 112, server 108 enforces a second authentication scheme that is different from the first authentication scheme. For example, authentication component 170 performs an authentication translation in a manner that is transparent to both client device 104 and server 112. To illustrate, using authentication component 170, the second authentication scheme is enforced by server 108 translating the first credential into a second credential that is used to sign the corresponding message sent to server 112. This server to server authentication is based on a secure session (e.g., SSL session) using a pre-established certificate securely stored by server 108. This pre-established certificate is used to sign messages sent by server 108 to server 112 and is not known by client device 104, which enforces a level of security between client device 104 and server 112.

The second authentication scheme is used to further authenticate response messages received by server 108 from server 112 based on the callback link (which is based on the unique identifier for the session) that was previously provided by server 108.

The above-mentioned certificates can be stored by authentication component, as represented by block 171.

To illustrate one particular example, assume server 108 receives an event message from client device 104 in accordance with the first authentication scheme (e.g., signed with a first credential) established between client device 104 and server 108. Then, using authentication component 170, the second authentication scheme is enforced by server 108 translating the first credential into a second credential that is used to sign the corresponding message sent to server 112. When server 108 receives an event message from server 112 in accordance with the second authentication scheme, proxy component 172 stores the event message until the client device 104 is ready to accept it. When client device 104 requests the event message (and/or one or more additional event messages stored by proxy component 172), server 108 enforces the first authentication scheme to forward the message(s) on to client device 104. As such, server 108 can be seen as mediating the authentication between client device 104 and server 108, such as by translating between client-side and server-side credentials that are associated with the session. This can maintain session security even though the protocol functionality resides on the client side. In other words, client device 104 performs event message generation and processing (and/or other session related functionality) such as receiving a message originating from server 112, parsing the message to understand its contents, and generating a response event message to be sent back to server 112 in controlling the service(s). Server 108 enforces the server-side authentication using credentials that are unavailable (or at least not readily available) to client device 104.

FIG. 7 is a flow diagram of one example of a method 500 in which a developer utilizes a client-side development component to develop protocol logic. For sake of illustration, but not by limitation, method 500 will be described in the context of user 102 using development component 177 shown in FIG. 1.

At block 502, an input is detected that indicates a desire to develop service-level protocol logic. For example, user 102 can interact with user interface displays 134 to initiate a development application to develop new protocol logic components and/or to modify existing protocol logic components, such as components 184 stored in data store 160. In one example in which user 102 desires to extend the functionality of, or otherwise develop on, existing protocol logic components, protocol logic components can be transferred to client device 104 at block 504. For example, a set of protocol logic components 186 can be transferred from email server 108 to client device 104 using transfer components 174 and 180.

At block 506, a developer user interface with developer user input mechanisms is displayed and, at block 508, user interaction with the developer user input mechanisms is detected. The user interaction defines modifications or other developments on the protocol logic components. For example, but not by limitation, the development can be with respect to application capabilities, such as adding new features, removing features, or changing existing features. This is represented at block 510. Alternatively, or in addition, the development can be with respect to the user experience, such as by changing the user interface flow, dialogs, displays, etc. This is represented at block 512. For instance, at block 508, the developer can define how email server 108 responds to a call from server 112 that a participant left the meeting. Further, the developer can define a particular user interface or set of user interfaces that facilitates language translations within the meeting session. These, of course, are examples only.

At block 514, the protocol logic components are modified based on the development inputs. At block 516, runtime component 182 runs the protocol logic components from client device 104 for testing the developed protocol logic components.

At block 518, data is received from email server 108 indicative of the communication protocol between servers 108 and 112. Using this information, which can be displayed in the developer user interface, user 102 can determine whether further development is needed at 520.

Once the protocol logic is sufficiently developed, the protocol logic can be transmitted to email server 108 for storage and subsequent use across other client devices. In this manner, protocol logic can be developed on one client device, and then reused across other client devices. For instance, one user may develop the protocol logic with a first set of functionality, and a second user can further develop the protocol logic to provide extended functionality for another application. The protocol logic transfer is done using the corresponding transfer components 174 and 180.

Further, the protocol logic components can be developed across different code languages and platforms. In one example, the logic can be codified on client device 104 using a first coding language, such as JavaScript, and then copied to server 108 where it is maintained in a different language, such as C#. In any case, this example facilitates a centralized server mode in which protocol logic components 186 can be stored on email server 108 and transferred to various client devices for further development and/or client-side deployment.

FIG. 8 is a flow diagram illustrating one example of a method 550 in which the protocol between servers 108 and 112 is driven from a client-side (e.g., using runtime component 182 on client device 104). For sake of the present example, but not by limitation, it is assumed that a meeting session is setup in a manner similar to that illustrated in FIG. 3 at blocks 301-328. However, when email server 108 receives callbacks or other data from communication server 112, email server 108 stores this data (e.g., as protocol event data 188). Then, the data can be forwarded to client device 104 in response to a request from client device 104. For instance, at block 552 client device 104 can periodically poll email server 108 for a list of server callbacks 554 and/or protocol events 556 received from communication server 112. In one example, these are provided as digital traces 558.

At block 560, runtime component 182 generates an application-specific response or call using the protocol logic components 184 running on client device 104. In one example, runtime component 182 comprises an application protocol driver that runs in a browser for processing and responding to specific protocol events received through email server 108. The responses or calls generated by client device 104 are sent from client device 104 to email server 108, at block 562.

To provide an example, for sake of illustration, assume that email server 108 receives a callback from server 112 indicating that a participant has joined the meeting session. Email server 108 stores this callback and forwards it on to client device 104. Then, based on this information, runtime component 182 identifies a response to the callback. In the present example, client device 104 determines that the joined participant is the organizer and generates a response that instructs communication server 112 to add the other participants to the meeting session. In one example, this response is directed at a particular application programming interface (API) of communication server 112 (e.g., an AddParticipantAPl).

In the illustrated example, the responses generated by client device 104 are sent to email server 108, which acts as a proxy for client device 104 to send the responses to server 112. This is represented in FIG. 8 at block 564.

In one example of block 564, multi-level authentication is performed by server 108, such as the examples discussed above. As shown in FIG. 8, client device 104 is authenticated by email server 108 at block 566, for example using an authentication cookie or other credential in association with a browser of client device 104. Email server 108 can authorize the client response based on this authentication, at block 568. Further, email server 108 can authenticate with communication server 112 using, for example, a certificate to sign the response sent to communication server 112.

At block 572, it is determined whether additional data is received by email server 108. If so, the method returns to block 552 in which email server 108 stores and forwards this data to client device 104.

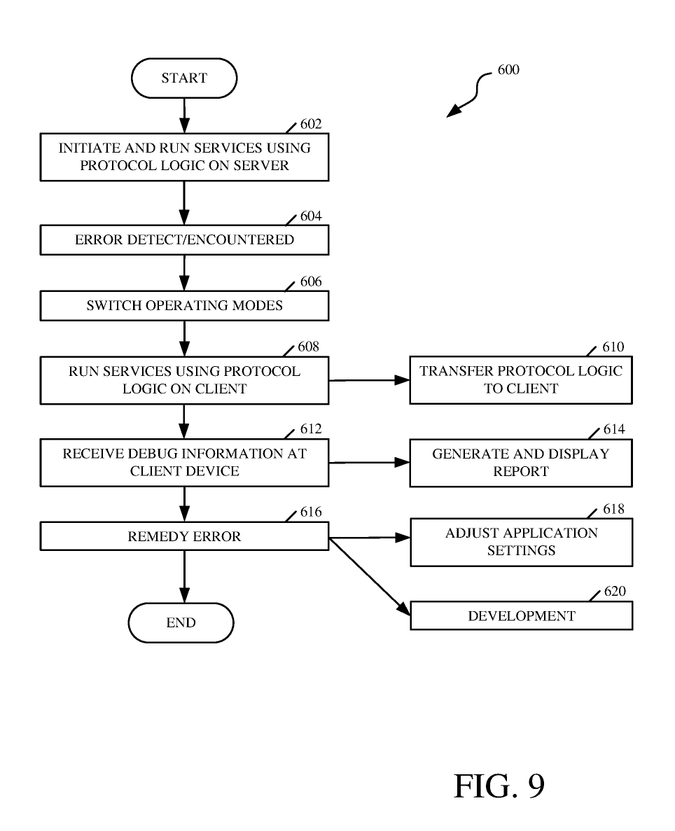

In accordance with one example, architecture 100 can be configured to operate in different modes for controlling the protocol between servers 108 and 112. For example, email server 108 can include a mode switching component 190 configured to switch between the client driven mode, discussed above, and a server driven mode in which the protocol logic components 186 are run on email server 108. FIG. 9 is a flow diagram of one example of a method 600 that utilizes mode switching component 190.

At block 602, the services are initiated and run using protocol logic components executing on email server 108 (e.g., server 108 generates the event messages to server 112). For example, an initial meeting request (e.g., meeting request 204) can define whether the protocol logic should be run on email server 108, as opposed to client device 104.

At block 604, an error is detected. At block 606, the operating modes are switched, such that the protocol logic instead is run on client device 104 at block 608. In one example, this includes transferring the protocol logic to client device 104 at block 610. In another example, the protocol logic components 184 can preexist on client device 104, even though the protocol logic is being run from email server 108. In this example, architecture 100 can easily switch from the server deployment to the client deployment, for example by providing the user with a query parameter, cookie, and/or otherwise switching the user interface on client device 104.

At block 612, debug information is received at client device 104, for example by polling email server 108 for protocol event data 188. In one example, at block 614, using the protocol event data 188 a report can be generated and displayed to the user on client device 104 that identifies or otherwise indicates the protocol event messages received from and sent to server 108. For instance, the report shows the event messages received by server 108 from server 112 (and forwarded to client device 104) and the corresponding responses generated by client device 104 to those event messages. This facilitates user 102 understanding the protocol events on the server-side, identifying errors or other issues that arise in the protocol events, and debugging those issues.

At block 616, user 102 (or other user) utilizes the information received at block 612 to remedying the error(s) at block 616. For example, application settings can be adjusted to remedy the error at block 618. For instance, in a case where the error occurred due to a service-level translation problem, the application settings can be adjusted to disable relevant translation components. In another example, the user can develop the application based on the error at step 620, such as by modifying the application protocol logic code that caused the error.

It can thus be seen that the present discussion provides significant technical advantages. For example, it provides an improved development environment that reduces user development time in developing the protocol logic for the server-side communications, thus allowing the development to reach production more quickly. Further, the present environment allows client-side visibility into the server-side communications which facilitates scalable run-time analysis which can be utilized to improve performance of the services (e.g., error identification and correction, etc.). Additionally, the environment facilitates service security by enforcing a client authentication scheme using server-side credentials. Further yet, the developed protocol logic components are reusable across multiple different client devices.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, user interface component(s) generating a number of user interface displays have been discussed. They can take a wide variety of different forms and can have a wide variety of different user actuatable input mechanisms disposed thereon, for example to sense physical activities of the user. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

Also, the figures show a number of blocks with functionality ascribed to each block. It will be noted that fewer blocks can be used so the functionality is performed by fewer components. Also, more blocks can be used with the functionality distributed among more components. Further, it is noted that the described systems of architecture 100 can be local to one another or can be located remotely from each other. For example, systems 108 and 112 can be located remotely from one another (such as on a different server in a different geographic region).

It will be noted that the above discussion has described a variety of different systems, components, modules, elements, and/or types of items. It should be understood that these can be implemented in any of a variety of ways. For example, they can be implemented as logic. It will be appreciated that such systems, components, and/or logic can be comprised of hardware items (such as processors and associated memory, or other processing components, some of which are described above) that perform the functions associated with those systems, components and/or logic. In addition, the systems, components and/or logic can be comprised of software that is loaded into a memory and is subsequently executed by a processor or server, or other computing component, as described above. The systems, components and/or logic can also be comprised of different combinations of hardware, software, firmware, etc., some examples of which are described herein. These are only some examples of different structures that can be used to form the systems, components and/or logic described above. Other structures can be used as well.

It should also be noted that the discussion herein includes one or more data stores including data stores 122, 132, and 160. The data stores can be any of a variety of different types of data stores. Further, the data in the data stores can be consolidated into a same data store, and can be stored in multiple additional data stores as well. Also, the data stores can be local to the environments, agents, modules, and/or components that access them, or they can be remote therefrom and accessible by those environments, agents, modules and/or components. Similarly, some can be local while others remote.

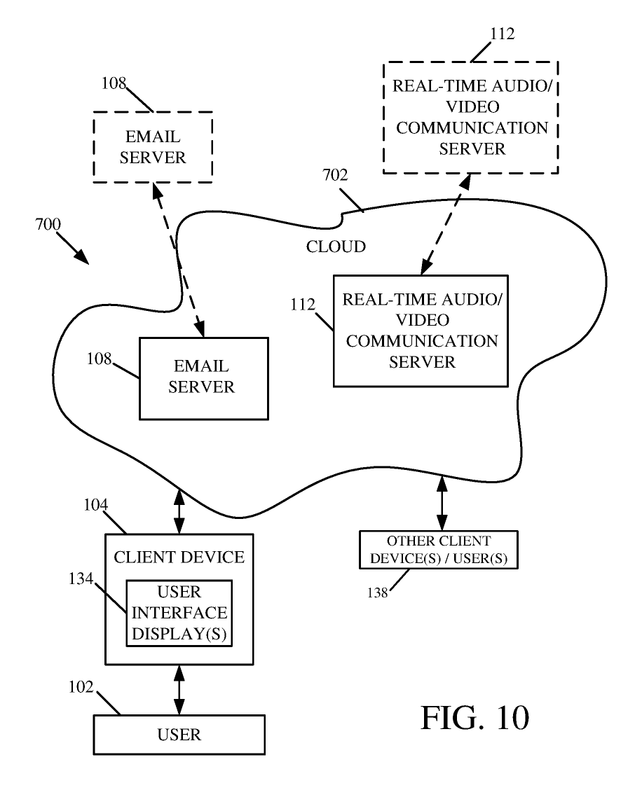

FIG. 10 is a block diagram of architecture 100, shown in FIG. 1, in which its elements are disposed in example cloud computing architecture 700. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, et cetera.

In the example shown in FIG. 10, some items are similar to those shown in FIG. 1 and they are similarly numbered. FIG. 10 specifically shows that some or all components of architecture 100 are located in cloud 702 (which can be public, private, or a combination where portions are public while others are private). Therefore, user 102 uses client device 104 to access those components through cloud 702.

FIG. 10 also depicts another example of a cloud architecture. FIG. 10 shows that it is also contemplated that some elements of architecture 100 are disposed in cloud 702 while others are not. In one example, email server 108 can be disposed outside of cloud 702, and accessed through cloud 702. In another example, real-time audio/video communication server 112 can be disposed outside of cloud 702, and accessed through cloud 702. Regardless of where they are located, the elements of architecture 100 can be accessed directly by client device 104, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, et cetera.

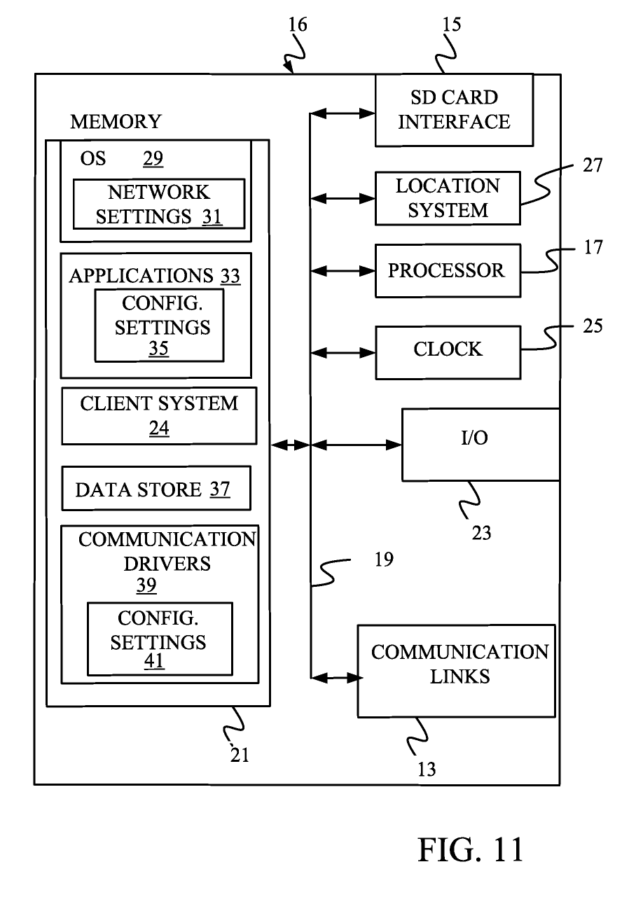

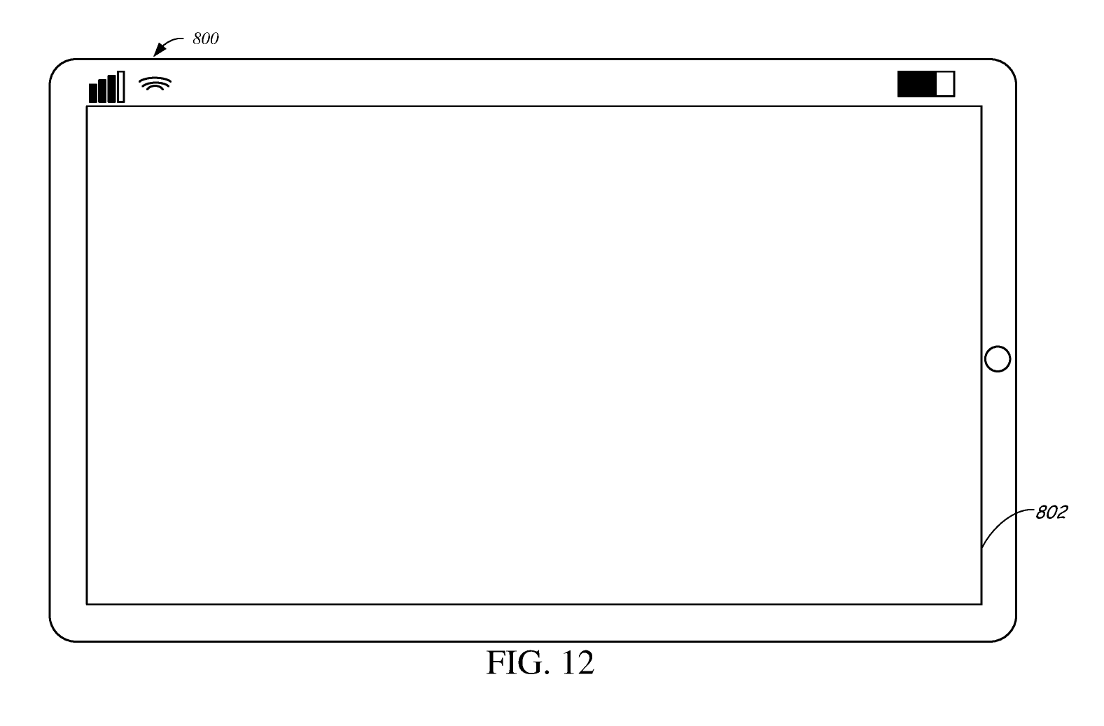

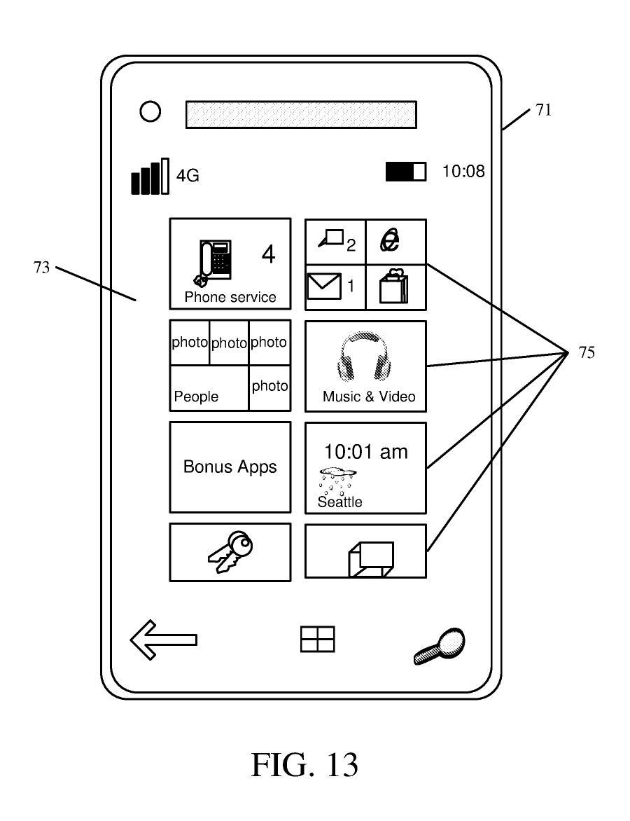

FIG. 11 is a simplified block diagram of one illustrative embodiment of a handheld or mobile computing device that can be used as a user's or client's hand held device 16, in which the present system (or parts of it) can be deployed. FIGS. 12-13 are examples of handheld or mobile devices.

FIG. 11 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Items in data store 160, for example, can reside in memory 21. Similarly, device 16 can have a client system 24 which can run various applications. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 12 shows one embodiment in which device 16 is a tablet computer 800. In FIG. 12, computer 800 is shown with user interface display displayed on the display screen 802. Screen 802 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 800 can also illustratively receive voice inputs as well.

Additional examples of devices 16 can be used, as well. Device 16 can be a feature phone, smart phone or mobile phone. The phone includes a set of keypads for dialing phone numbers, a display capable of displaying images including application images, icons, web pages, photographs, and video, and control buttons for selecting items shown on the display. The phone includes an antenna for receiving cellular phone signals such as General Packet Radio Service (GPRS) and 1×rtt, and Short Message Service (SMS) signals. In some embodiments, phone also includes a Secure Digital (SD) card slot that accepts a SD card.

The mobile device can be personal digital assistant (PDA) or a multimedia player or a tablet computing device, et cetera (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA also includes a number of user input keys or buttons which allow the user to scroll through menu options or other display options which are displayed on the display, and allow the user to change applications or select user input functions, without contacting the display. Although not shown, the PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device also includes a SD card slot that accepts a SD card.

FIG. 13 shows that the phone is a smart phone 71. Smart phone 71 has a touch sensitive display 73 that displays icons or tiles or other user input mechanisms 75. Mechanisms 75 can be used by a user to run applications, make calls, perform data transfer operations, et cetera. In general, smart phone 71 is built on a mobile operating system and offers more advanced computing capability and connectivity than a feature phone.

Note that other forms of the devices 16 are possible.

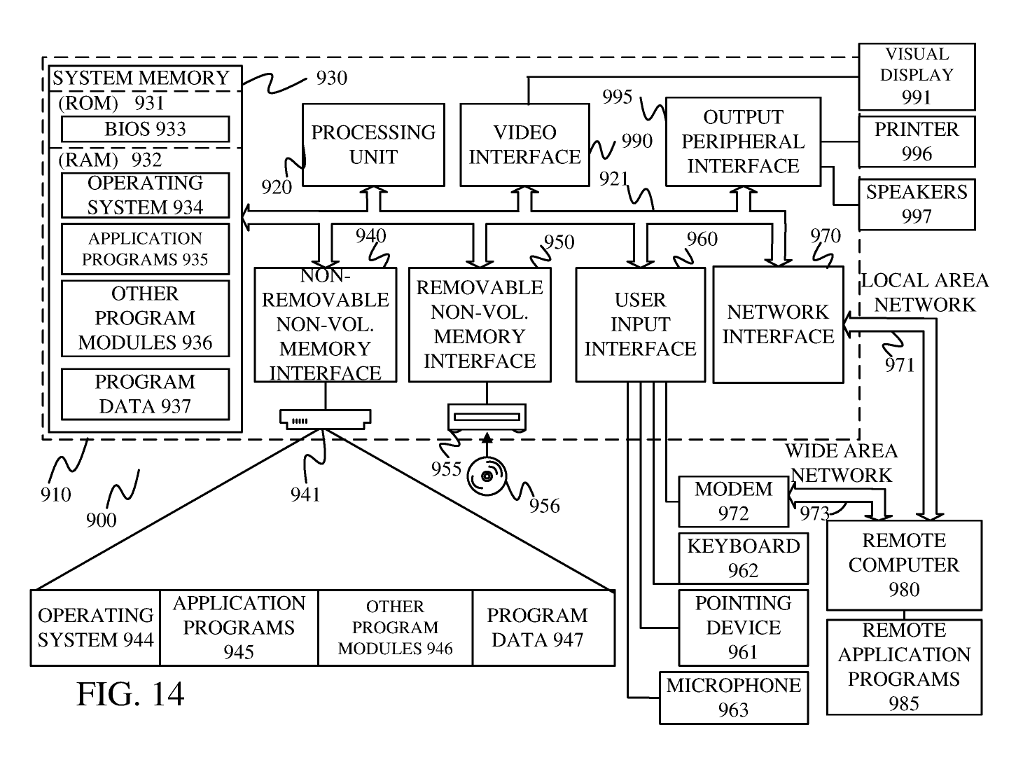

FIG. 14 is one embodiment of a computing environment in which architecture 100, or parts of it, (for example) can be deployed. With reference to FIG. 14, an exemplary system for implementing some embodiments includes a general-purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro

Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 14.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 14 illustrates operating system 934, application programs 935, other program modules 936, and program data 937.

The computer 910 may also include other removable/non-removable volatile/nonvolatile computer storage media. By way of example only, FIG. 14 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), et cetera.

The drives and their associated computer storage media discussed above and illustrated in FIG. 14, provide storage of computer readable instructions, data structures, program modules and other data for the computer 910. In FIG. 14, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies.

A user may enter commands and information into the computer 910 through input devices such as a keyboard 962, a microphone 963, and a pointing device 961, such as a mouse, trackball or touch pad. Other input devices (not shown) may include a joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A visual display 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 is operated in a networked environment using logical connections to one or more remote computers, such as a remote computer 980. The remote computer 980 may be a personal computer, a hand-held device, a server, a router, a network PC, a peer device or other common network node, and typically includes many or all of the elements described above relative to the computer 910. The logical connections depicted in FIG. 14 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 14 illustrates remote application programs 985 as residing on remote computer 980. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a client computing system comprising a communication interface configured to communicate with a server environment that hosts a set of application services that interact in accordance with a communication protocol to provide service functionality to the client computing system, a development component configured to develop the service functionality by generating a protocol logic component that controls messaging between the set of application services using the communication protocol, and a runtime component configured to generate a message on the client computing system using the protocol logic component and send the message to the server environment.

Example 2 is the client computing system of any or all previous examples, wherein the protocol logic component comprises a script that executes on the client computing system to generate the message.

Example 3 is the client computing system of any or all previous examples, wherein the message comprises a response to a protocol event message received from the server environment.

Example 4 is the client computing system of any or all previous examples, and further comprising a user interface component configured to generate a user interface display that displays an indication of the protocol event message and the response generated by the runtime component.

Example 5 is the client computing system of any or all previous examples, wherein the communication protocol comprises a chatty protocol and the server environment comprises first and second application services that communication in accordance with the chatty protocol.

Example 6 is the client computing system of any or all previous examples, wherein the server environment comprises a first server that hosts a first application service and a second server that hosts a second application service that is different than the first application service.

Example 7 is the client computing system of any or all previous examples, wherein the first application service is substantially independent from the second application server, and wherein the first server mediates the second application service provided by the second server.

Example 8 is the client computing system of any or all previous examples, wherein the message comprises an application specific response that targets a particular application programming interface (API) of the second server.

Example 9 is the client computing system of any or all previous examples, wherein the first server operates as a proxy to send the application specific response to the second server.

Example 10 is the client computing system of any or all previous examples, wherein the first and second servers communicate in accordance with a pre-established authentication scheme.

Example 11 is the client computing system of any or all previous examples, wherein the client device and the first server communicate in accordance with an authentication scheme that is different than the pre-established authentication scheme between the first and second servers.

Example 12 is the client computing system of any or all previous examples, wherein the first server comprises a messaging server and the second server comprises a real-time communication server.

Example 13 is the client computing system of any or all previous examples, wherein the real-time communication server hosts a group meeting session, and the message instructs the real-time communication server to perform a meeting function within the group meeting session.

Example 14 is the client computing system of any or all previous examples, wherein the development component comprises a protocol logic transfer component configured to receive a set of protocol logic components from the server environment and to store the set of protocol logic components on the client device, and wherein the development component is configured to develop the service functionality by modifying the set of protocol logic components.

Example 15 a computer system comprising a service component configured to provide a first application service to a client device, a communication interface configured to communicate with the client device and a second application service, an authentication component configured to authenticate the client device using a first authentication scheme and authenticate the second application service using a second authentication scheme, and a proxy component. The proxy component is configured to receive an event message from the second application service, send the event message to the client device, receive a response to the event message from the client device, and send the response to the second application service.

Example 16 is the computer system of any or all previous examples, wherein the computing system comprises a first server and the second application service is hosted on a second server, and wherein the authentication component is configured to authenticate the client device using a first credential and to authenticate the second server using a second credential.

Example 17 is the computer system of any or all previous examples, wherein the proxy component is configured to store and forward the event message to the client device.

Example 18 is the computer system of any or all previous examples, wherein the response is generated by the client device using a protocol logic component executed by the client device.

Example 19 is the computer system of any or all previous examples, and further comprising a protocol logic transfer component, and a mode switching component configured to receive a protocol logic transfer request, and, based on the protocol logic transfer request, transfer the protocol logic component from the computing system to the client device using the protocol logic transfer component.

Example 20 is a computer-implemented method comprising generating a client interface at a client device, receiving a development input through the client interface indicative of a development of service functionality in a server environment, wherein the server environment hosts a set of application services that interact in accordance with a communication protocol, generating a protocol logic component based on the development input using a computer processor, receiving an event message from the server environment indicative of a service event in the server environment, generating a response to the event message using the protocol logic component on the client device, and sending the response to the server environment.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What is claimed is:

1. A client computing system comprising:
a communication interface configured to communicate with a server environment that hosts a set of application services that interact in accordance with a communication protocol to provide service functionality to the client computing system;
a development component configured to develop the service functionality by generating a protocol logic component that controls messaging between the set of application services using the communication protocol; and
a runtime component configured to:
generate a message on the client computing system using the protocol logic component; and
send the message to the server environment.

2. The client computing system of claim 1, wherein the protocol logic component comprises a script that executes on the client computing system to generate the message.

3. The client computing system of claim 2, wherein the message comprises a response to a protocol event message received from the server environment.

4. The client computing system of claim 3, and further comprising a user interface component configured to generate a user interface display that displays an indication of the protocol event message and the response generated by the runtime component.

5. The client computing system of claim 1, wherein the communication protocol comprises a chatty protocol and the server environment comprises first and second application services that communication in accordance with the chatty protocol.

6. The client computing system of claim 1, wherein the server environment comprises a first server that hosts a first application service and a second server that hosts a second application service that is different than the first application service.

7. The client computing system of claim 6, wherein the first application service is substantially independent from the second application server, and wherein the first server mediates the second application service provided by the second server.

8. The client computing system of claim 6, wherein the message comprises an application specific response that targets a particular application programming interface (API) of the second server.

9. The client computing system of claim 6, wherein the first server operates as a proxy to send the application specific response to the second server.

10. The client computing system of claim 9, wherein the first and second servers communicate in accordance with a pre-established authentication scheme.

11. The client computing system of claim 10, wherein the client device and the first server communicate in accordance with an authentication scheme that is different than the pre-established authentication scheme between the first and second servers.

12. The client computing system of claim 6, wherein the first server comprises a messaging server and the second server comprises a real-time communication server.

13. The client computing system of claim 12, wherein the real-time communication server hosts a group meeting session, and the message instructs the real-time communication server to perform a meeting function within the group meeting session.

14. The client computing system of claim 1, wherein the development component comprises a protocol logic transfer component configured to receive a set of protocol logic components from the server environment and to store the set of protocol logic components on the client device, and wherein the development component is configured to develop the service functionality by modifying the set of protocol logic components.

15. A computing system comprising:
a service component configured to provide a first application service to a client device;
a communication interface configured to communicate with the client device and a second application service;
an authentication component configured to authenticate the client device using a first authentication scheme and authenticate the second application service using a second authentication scheme; and
a proxy component configured to:
receive an event message from the second application service;
send the event message to the client device;
receive a response to the event message from the client device; and
send the response to the second application service.

16. The computing system of claim 15, wherein the computing system comprises a first server and the second application service is hosted on a second server, and wherein the authentication component is configured to authenticate the client device using a first credential and to authenticate the second server using a second credential.

17. The computing system of claim 15, wherein the proxy component is configured to store and forward the event message to the client device.

18. The computing system of claim 15, wherein the response is generated by the client device using a protocol logic component executed by the client device.

19. The computing system of claim 18, and further comprising:
a protocol logic transfer component; and
a mode switching component configured to:
receive a protocol logic transfer request; and
based on the protocol logic transfer request, transfer the protocol logic component from the computing system to the client device using the protocol logic transfer component.

20. A computer-implemented method comprising:
generating a client interface at a client device;
receiving a development input through the client interface indicative of a development of service functionality in a server environment, wherein the server environment hosts a set of application services that interact in accordance with a communication protocol;
generating a protocol logic component based on the development input using a computer processor;
receiving an event message from the server environment indicative of a service event in the server environment;
generating a response to the event message using the protocol logic component on the client device; and
sending the response to the server environment.
